(19) United States
(12) Patent Application Publication
(10) Pub. No.: US 2014/0355765 A1
(43) Pub. Date: Dec. 4, 2014

(54) MULTI-DIMENSIONAL PARAMETRIC AUDIO SYSTEM AND METHOD

(71) Applicants: Richard Joseph Kulavik, San Jose, CA (US); Elwood Grant Norris, Poway, CA (US); Brian Alan Kappus, San Diego, CA (US)

(72) Inventors: Richard Joseph Kulavik, San Jose, CA (US); Elwood Grant Norris, Poway, CA (US); Brian Alan Kappus, San Diego, CA (US)

(73) Assignee: Turtle Beach Corporation, Poway, CA (US)

(21) Appl. No.: 14/457,588

(22) Filed: Aug. 12, 2014

Related U.S. Application Data
(63) Continuation-in-part of application No. 13/969,292, filed on Aug. 16, 2013.
(60) Provisional application No. 61/864,757, filed on Aug. 12, 2013.
(60) Provisional application No. 61/684,028, filed on Aug. 16, 2012.

(51) Int. Cl. H04S 7/00; H04S 5/00

(52) U.S. Cl. CPC H04S 7/302; H04S 5/005; H04S 2400/01; H04S 2420/01
USPC 381/17

(57) ABSTRACT

Systems and methods that use ultrasonic emitters for producing multi-dimensional parametric audio are provided. The systems and methods can be configured to determine HRTF filters for the left and right ears of a listener using an optical imaging system to scan a profile of a listener. Audio content may be encoded into a left and right channel for producing a three dimensional sound effect for the listener of the audio content by: processing the sound channel into left and right input channel signals; applying the HRTF filters and acoustic crosstalk cancellations filters to the left and right channel signals to generate output left and right channel signals; and modulating the left and right output channel signal frequencies onto an ultrasonic carrier.

### REFERENCE TO RELATED APPLICATIONS

This application claims priority to U.S. Provisional Patent Application No. 61/864,757, filed Aug. 12, 2013, and is a continuation-in-part and claims priority to U.S. patent application Ser. No. 13/969,292, filed Aug. 16, 2013, which claims priority to U.S. Provisional Patent Application No. 61/684,028, filed Aug. 16, 2012, all of which are incorporated herein by reference in their entirety.

### TECHNICAL FIELD

The present invention relates generally to audio systems, and more particularly, some embodiments relate to multi-dimensional audio processing for ultrasonic audio systems.

### BACKGROUND OF THE INVENTION

Surround sound or audio reproduction from various positions about a listener can be provided using several different methodologies. One technique uses multiple speakers encircling the listener to play audio from different directions. An example of this is Dolby® Surround Sound, which uses multiple speakers to surround the listener. The Dolby 5.1 process digitally encodes five channels (plus a subwoofer) of information onto a digital bitstream. These are the Left Front, Center Front, Right Front, Surround Left, and a Surround Right. Additionally, a Subwoofer output is included (which is designated by the “0.1”). A stereo amplifier with Dolby processing receives the encoded audio information and decodes the signal to derive the 5 separate channels. The separate channels are then used to drive five separate speakers (plus a subwoofer) placed around the listening position.

Dolby 6.1 and Dolby 7.1 are extensions of Dolby 5.1. Dolby 6.1 includes a Surround Back Center channel. Dolby 7.1 adds left and right back speakers that are preferably placed behind the listening position and the surround speakers are set to the sides of the listening position. An example of this is provided in FIG. 1. Referring now to FIG. 1, the conventional Dolby 7.1 system includes Left Front (LF), Center, Right Front (RF), Left Surround (LS), Right Surround (RS) Back Surround Left (BSL) and Back Surround Right (BSR). Additionally, a Subwoofer, or Low Frequency effects (LFE), is shown.

Upon playback, decoders at the audio amplifier decode the encoded information in the audio stream and break up the signal into its constituent channels—e.g., 7 channels plus a subwoofer output for Dolby 7.1. The separate channels are amplified and sent to their respective speakers. One downside of Dolby 7.1 and other multi-speaker surround sound systems is that they require more than two speakers. Moreover, such multi-speaker surround sound systems require placement of the speakers around the listening environment. These requirements can lead to increased cost, additional wiring and practical difficulties with speaker placement.

Additionally, the sound created by the conventional speakers is always produced on the face of the speaker (i.e., at the speaker cone). The sound wave created at the surface propagates through the air in the direction at which the speaker is pointed. In simplest terms, the sound will appear to be closer or farther away from the listener depending on how far away from the listener the speaker is positioned. The closer the listener is to the speaker, the closer the sound will appear. The sound can be made to appear closer by increasing the volume, but this effect is limited.

In a surround sound speaker system using conventional speakers, speakers may be placed to ‘surround’ the listener, but it is apparent that the sound is produced at discrete points along the perimeter corresponding to the position of the speakers. This is apparent when listening to content in a surround-sound environment. In such environments, the sound can appear to move from one speaker to another, but it always sounds like its source is the speaker itself—which it is. Phasing can have the effect of blending sound between speakers, but conventional surround sound systems cannot achieve placement or apparent placement of sound in the environment at determined distances from a listener or listening location.

Moreover, even this limited ‘surround’ effect cannot be achieved with only a pair conventional speakers. Introducing audio processing effects to a two-channel (Left/Right) system can allow the sound to appear to move from the left speaker to the right speaker, but the sound cannot be placed at a desired distance from or beyond the listener.

### BRIEF SUMMARY OF THE DISCLOSURE

According to various embodiments of the disclosed methods and systems, multi-dimensional audio processing is provided for ultrasonic audio systems. In one embodiment, a parametric audio encoder in an audio system is configured to process a sound channel into left input and right input channel signals; apply HRTF filters to the left and right input channel signals to generate adjusted left and adjusted right channel signals; apply acoustic crosstalk cancellation filters to the adjusted left and adjusted right channel signals; and modulate the left and right output channel signal frequencies onto an ultrasonic carrier to generate modulated left output and right output channel signals for playback by a left ultrasonic emitter and a right ultrasonic emitter.

In one embodiment, HRTF filters for the left and right ears of the a listener are determined by scanning the listener with an optical imaging system to determine a profile of the listener. In one implementation of this embodiment, the profile of the listener comprises the head, pinna, and torso measurements of the listener. In further implementations of this embodiment, the HRTF filters are determined by comparing the scanned profile of the user with a predetermined set of HRTF profiles, each profile including a predetermined range of head, pinna, and torso measurements; and automatically selecting one of the predetermined set of HRTF profiles.

In yet another embodiment, determining HRTF filters for the left and right ears of the listener includes playing a plurality of sound samples at a predetermined frequency; recording the sound samples at a plurality of microphones, placed in the listener's left and right ears during recording; and recording the listener's position relative to the left and right ultrasonic emitters using the optical imaging system when each sound sample is recorded.

In one embodiment, applying acoustic crosstalk cancellation filters to the adjusted left and adjusted right channel signals to generate left and right output channel signals includes: phase inverting the adjusted right channel signal and the adjusted left channel signal; adding a delay to the phase inverted right channel signal and to the phase inverted left channel signal; combining the adjusted left channel signal with the delayed phase inverted adjusted right channel signal to generate the left output channel signal; and combining the adjusted right channel signal with the delayed phase inverted adjusted left channel signal to generate the right output channel signal.

Other features and aspects of the disclosed method and apparatus will become apparent from the following detailed description, taken in conjunction with the accompanying drawings, which illustrate, by way of example, the features in accordance with embodiments of the disclosure. The summary is not intended to limit the scope of the claimed disclosure, which is defined solely by the claims attached hereto.

### BRIEF DESCRIPTION OF THE DRAWINGS

FIG. 1 illustrates the conventional Dolby® Surround Sound configuration, with components for Dolby 5.1, 6.1, or 7.1 configurations.

FIG. 2 illustrates an example encoding and decoding process in accordance with various embodiments of the technology described herein.

FIG. 3 is a flow diagram of the method of creating a parametric audio signal from a previously signal encoded for use in a conventional surround sound system in accordance with various embodiments of the technology described herein.

FIG. 4 is a flow diagram of the method of encoding an audio component to produce a parametric audio signal in accordance with various embodiments of the technology described herein.

FIG. 5A is a diagram illustrating example circuitry of a parametric encoder that may be implemented to encode a sound channel into left and right ultrasonic frequency modulated output channel signals in accordance with various embodiments of the technology described herein.

FIG. 5B is an operational flow diagram illustrating an example method of encoding a sound channel that may be implemented with the parametric encoder circuitry of FIG. 5A.

FIG. 6A illustrates an example embodiment of the invention where ultrasonic emitters direct the parametric audio signal directly towards either the left or right sides of a particular listening position.

FIG. 6B illustrates an example embodiment of the invention where ultrasonic emitters reflect the parametric audio signal off a wall, ceiling, and/or floor.

FIG. 7 illustrates an example embodiment of a hybrid embodiment where the method of parametric audio production and ultrasonic emitters in accordance with embodiments of the invention is combined with a conventional surround sound configuration.

FIG. 8 illustrates an example computing module that may be used in implementing various features of embodiments of the technology described herein.

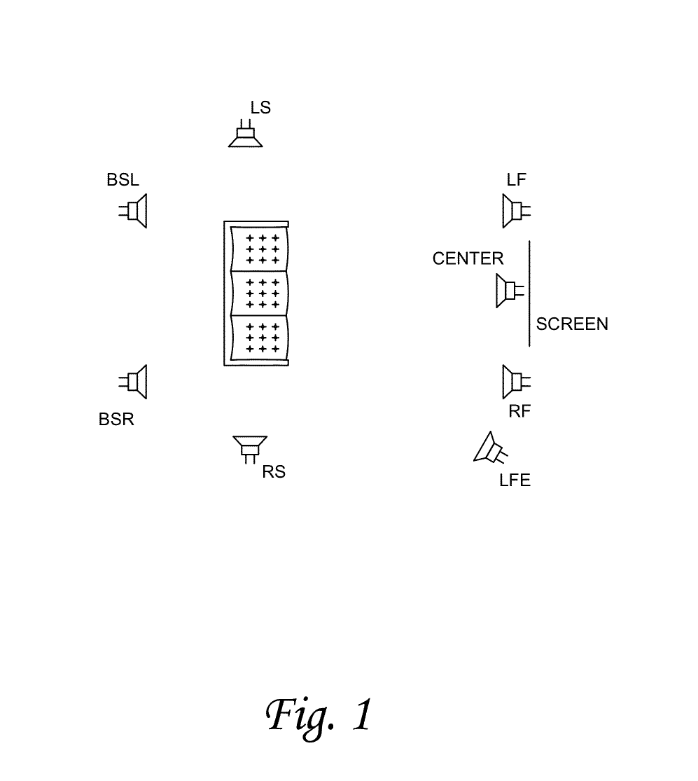

### DESCRIPTION OF EMBODIMENTS OF THE INVENTION

Embodiments of the systems and methods described herein provide multidimensional audio or a surround sound listening experience using as few as two emitters.

Monaural and Stereo playback has been achieved using non-linear transduction through a parametric array. Non-linear transduction, such as a parametric array in air, results from the introduction of audio-modulated ultrasonic signals into an air column. Self-demodulation, or down-conversion, occurs along the air column resulting in the production of an audible acoustic signal. This process occurs because of the known physical principle that when two sound waves of sufficient intensity with different frequencies are radiated simultaneously in the same medium, a modulated waveform including the sum and difference of the two frequencies is produced by the non-linear (parametric) interaction of the two sound waves. When the two original sound waves are ultrasonic waves and the difference between them is selected to be an audio frequency, an audible sound can be generated by the parametric interaction.

While the theory of non-linear transduction has been addressed in numerous publications, commercial attempts to capitalize on this intriguing phenomenon have largely failed in practical applications where relatively high volume outputs are necessary due to distortion of the parametrically produced sound output.

According to various embodiments of the systems and methods described herein, various components of the audio signal can be processed such that the signal played through ultrasonic emitters creates a multi-dimensional sound effect. For example, and in accordance with some embodiments, a three-dimensional effect can be created using only two channels of audio, thereby allowing as few as two emitters to achieve the effect. In other embodiments, other quantities of channels and emitters are used.

With ultrasonic audio systems, the ultrasonic transducers, or emitters, that emit the ultrasonic signal can be configured to be highly directional. Accordingly, a pair of properly spaced emitters can be positioned such that one of the pair of emitters targets one ear of the listener or a group of listeners, and the other of the pair of emitters targets the other ear of the listener or group of listeners. The targeting can but need not be exclusive. In other words, sound created from an emitter directed at one ear of the listener or group of listeners can ‘bleed’ over into the other ear of the listener or group of listeners.

This can be thought of as being similar to the way a pair of stereo headphones targets each ear of the listener. However, using the audio enhancement techniques described herein and ultrasonic emitters targeting each ear, a greater degree of spatial variation can be accomplished than is achieved with conventional headphones or speakers. Headphones, for example, only allow control of the sound to the left and right sides of the listener and can blend sound in the center. They cannot provide front or rear placement of the sound. As noted above, surround sound systems using conventional speakers positioned around the listening environment can provide sources to the front of, sides of and behind the listener, but the sources of that sound are always the speakers themselves.

According to various embodiments described herein, adjusting the parameters of the signal, frequency components of the signal, or other signal components on the two ultrasonic channels (more channels can be used) relative to each other—such as the phase, delay, gain, reverb, echo, or other audio parameters—allows the audio reproduction of that signal or of component(s) within that signal, to appear to be positioned at a predetermined or desired location (not necessarily the speaker location) in the space about the listener(s). With ultrasonic emitters and ultrasonic-carrier audio, the audio can be generated by demodulation of the ultrasonic carrier in the air between the ultrasonic emitter and the listener (sometimes referred to as the air column). Accordingly, the actual sound is created at what is effectively an infinite number of points in the air between the emitter and the listener and beyond the listener. Therefore, in various embodiments these parameters are adjusted to emphasize an apparent sound generated at a chosen location in space. For example, the sound created (e.g., for a component of the audio signal) at a desired location can be made to appear to be emphasized over the sound created at other locations. Accordingly, with just one pair of emitters (e.g., a left and right channel), the sound can be made to appear to be generated at a point along one of the paths from the emitter to the listener at a point closer to or farther from the listener, whether in front of or behind the listener. The parameters can also be adjusted so that sound appears to come from the left or right directions at a predetermined distance from the listener. Accordingly, two channels can provide a full 360 degree placement of a source of sound around a listener, and at a chosen distance from the listener. As also described herein, different audio components or elements can be processed differently, to allow controlled placement of these audio components at their respective desired locations within the channel.

Adjusting the audio on two or more channels relative to each other allows the audio reproduction of that signal or signal component to appear to be positioned in space about the listener(s). Such adjustments can be made on a component or group of components (e.g., Dolby or other like channel, audio component, etc.) or on a frequency-specific basis. For example, adjusting phase, gain, delay, reverb, and echo, or other audio processing of a single signal component, can also allow the audio reproduction of that signal component to appear to be positioned in a predetermined location in space about the listener(s). This can include apparent placement in front of or behind the listener.

Additional auditory characteristics, such as, for example, sounds captured from auditorium microphones placed in the recording environment (e.g., to capture hall or ambient effects), may be processed and included in the audio signal (e.g., blending with one or more components) to provide more realism to the three-dimensional sound. In addition to adjusting the parameters on a component or element basis, the parameters can be adjusted based on frequency components.

Preferably, in one embodiment, various audio components are created with a relative phase, delay, gain, echo and reverb or other effects built into the audio component such that can be placed in spatial relation to the listening position upon playback. For example, computer-synthesized or computer-generated audio components can be created with or modified to have signal characteristics to allow placement of various audio components and their desired respective positions in the listening environment. As described above, the Dolby (or other like) components can be modified to have signal characteristics to allow apparent placement of various audio components and their desired respective positions in the listening environment.

As a further example, consider a computer-generated audio/video experience such as a videogame. In the 3-D gaming experience, the user is typically immersed into a world with the gaming action occurring around the user in that world in three dimensions. For example, in a shooting game or other war simulation game, the gamer may be in a battlefield environment that includes aircraft flying overhead, vehicles approaching from or departing to locations around the user, other characters sneaking up on the gamer from behind or from the side, gunfire at various locations around the player, and so on. As another example, consider an auto racing game where the gamer is in the cockpit of the vehicle. He or she may hear engine noise from the front, exhaust noise from the rear, tires squealing from the front or rear, the sounds of other vehicles behind, to the side and front of the gamer's vehicle, and so on.

Using a traditional surround sound speaker system, multiple speakers would be required, and the player would be able to tell the general direction from which the sound is emanating within the confines of the system, but would not be fully immersed in the 3-D environment. It would be apparent that the sound is produced at a discrete point around the perimeter of the listening field, and the sound cannot be made to appear to emanate from points closer to or farther from the listener. The sound only appears closer or farther away based on the strength of the signal at the listening point. For example, the player could tell that a particular sound came from the right side, but could not discern the actual distance—right beside the player, at the wall, etc. How close the object seemed would depend on the strength of the signal at the player's position, determined by the relative volumes of the speakers. However, this effect is limited, and adjusting relative volume alone does not necessarily provide. For example, changing the volume can give the appearance that distance is changing. However, in real world environments, volume alone is not the only factor used to judge distance. The character of a given sound beyond its volume changes as the source of the given sound moves farther away. The effects of the environment are more pronounced, for example.

Using the system and methods herein described, not only would the player be able to discern the direction of the sound but also the location from which the sound emanates in a three-dimensional environment. Moreover, this can be done with just two emitters. If the audio sound were a person positioned about 3 feet in front of the player and 5 feet to the left, the player would be able to determine where the sound came from. This is because the sound is created at specific spatial positions in the air column, not on the speaker face as is the case with traditional speakers. Changing the audio parameters discussed above can cause the sound to appear as if it is being created at (or in the vicinity of) that location 3 feet in front of the and 5 feet to the left of the player (or viewer/listener). An increase in volume would be equivalent to a person raising their voice—although what was said may be clearer, it does not necessarily sound closer. By using non-linear transduction as described above with the methods and system described herein, it is possible to create a three-dimensional audio experience, whereby sound actually created at one or more locations along the air column can be emphasized to place the source at any desired location. Therefore, spatial positioning of a particular sound may be accomplished.

By adding phase change, gain, phasor, flange, reverb and/or other effects to each of these audio objects, and by playing the audio content to the gamer using parametric sound through directional ultrasonic transducers, the user can be immersed in a three-dimensional audio experience using only two “speakers” or emitters. For example, increasing the gain of an audio component on the left channel relative to the right, and at the same time adding a phase delay on that audio component for the right channel relative to the left, will make that audio component appear to be positioned to the left of the user. Increasing the gain or phase differential (or both) will cause the audio component to appear as if it is coming from a position farther to the left of the user.

Different levels of this audio processing can be applied to different audio components to place each audio component properly in the environment. For example, when a game character in the game is approaching the user, each footstep of that character may be encoded differently to reflect that footstep's position relative to the prior or subsequent footsteps of that character. Thus applying different processing to each subsequent footstep audio component, the footsteps can be made to sound like they are moving toward the gamer from a predetermined location or moving away from the gamer to a predetermined position. Additionally, the volume of the footstep sound components can be likewise adjusted to reflect the relative distance of the footsteps as they approach or move away from the user.

Thus, a sequence of audio components that make up an event (such as footsteps of an approaching character) can be created with the appropriate phase, gain, or other difference to reflect relative movement. Likewise, the audio characteristics of a given audio component can be altered to reflect the changing position of the audio component. For example, the engine sound of the overtaking vehicle can be modified as the vehicle overtakes the gamer to position sound properly in the 3-D environment of the game. This can be in addition to any other alteration of the sound such as, for example, to add Doppler effects for additional realism. Likewise, additional echo can be added for sounds that are farther away, because as an object gets closer, its sound tends to drown out its echo. Additionally, stereo separation can be used to simulate the perception of distance by mixing an audio component between two audio channels so that the audio component is heard by both ears of the listener.

These techniques can also be used to provide a surround sound experience with surround sound encoded audio signals using only two “speakers” or emitters. For example, in various embodiments, a two-channel audio signal that has been encoded with surround sound components can be decoded to its constituent parts, the constituent parts can be re-encoded according to the systems and methods described herein to provide correct spatial placement of the audio components and recombined into a two-channel audio signal for playback using two ultrasonic emitters.

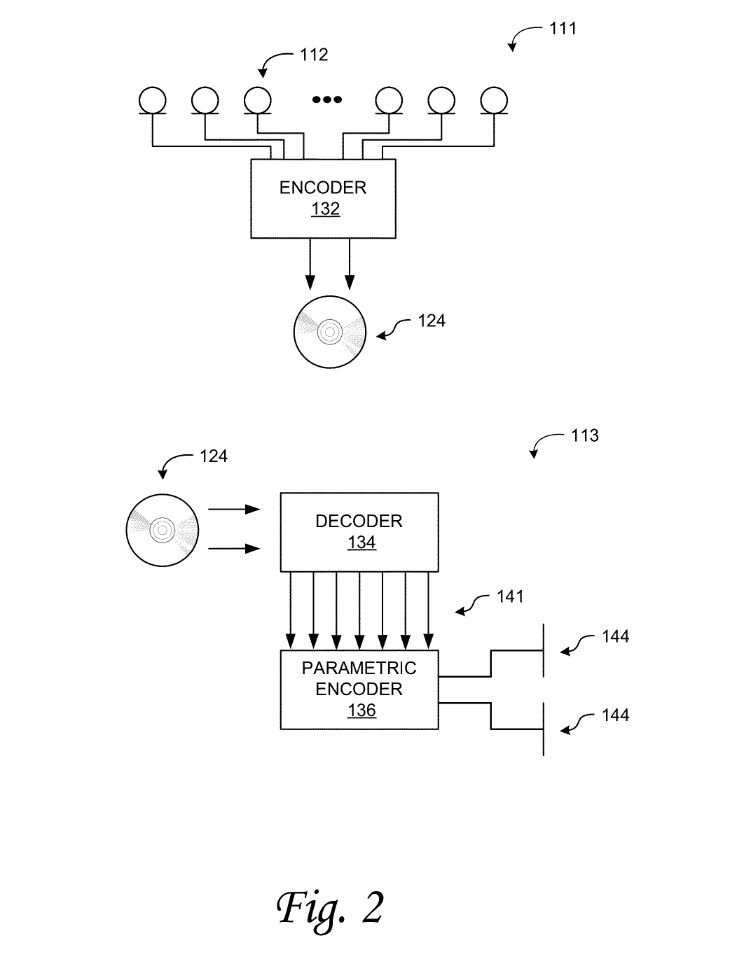

FIG. 2 is a diagram illustrating an example of a system for generating two-channel, multidimensional audio from a surround-sound encoded signal in accordance with one embodiment of the systems and methods described herein. Referring now to FIG. 2, the example audio system includes an audio encoding system 111 and an example audio playback system 113. The example audio encoding system 111 includes a plurality of microphones 112, an audio encoder 132 and a storage medium 124.

The plurality of microphones 112 can be used to capture audio content as it is occurring. For example, a plurality of microphones can be placed about a sound environment to be recorded. For example, for a concert a number of microphones can be positioned about the stage or within the theater to capture sound as it is occurring at various locations in the environment. Audio encoder or surround sound encoder 132 processes the audio received from the different microphone input channels to create a two channel audio stream such as, for example, a left and right audio stream. This two-channel audio stream encoded with information for each of the tracks or microphone input channels can be stored on any of a number of different storage media 124 such as, for example, flash or other memory, magnetic or optical discs, or other suitable storage media.

In the example described above with reference to FIG. 2, signal encoding from each microphone is performed on a track-by-track basis. That is, the location or position information of each microphone is preserved during the encoding process such that during subsequent decoding and re-encoding (described below) that location or position information affects the apparent position of the audio playback signal components. In other embodiments, encoding performed by audio encoder 132 separates the audio information into tracks that are not necessarily tied to, or that do not necessarily correspond on a one-to-one basis with each of the individual microphones 112. In other words, audio components can be separated into various channels such as center front, left front, right front, left surround, right surround, left back surround, right back surround, and so on based on content rather than based on which microphone was used to record the audio. An example of audio encoder is used to create multiple tracks of audio information encoded onto a two track audio stream is a Dolby Digital or Dolby surround sound processor. In this example, the audio recording generated by audio encoder 132 can store one storage medium 124 can be, for example, a Dolby 5.1 or 7.1 audio recording. In addition to recording the audio information, the content can be synthesized and assembled using purely synthesized sound or a combination of synthesized and recorded sounds.

In the example illustrated in FIG. 2 to reproduce the audio content in the listening environment, a decoder 134 and parametric encoder 136 are provided in the reproduction system 113. As illustrated in this example, the encoded audio content (in this case stored on media 124) 62-channel encoded audio content created by audio encoding system 111. Decoder 134 is used to decode the encoded two-channel audio stream into the multiple different surround sound channels 141 that make up the audio content. For example, in an embodiment where multiple microphones 112 are used to record multiple channels of audio content, coder 134 can re-create an audio channel 141 for each microphone channel 112. As another example, in the case of Dolby encoded audio content, coder 134 can be implemented as a Dolby decoder and the surround sound channels 141 are the re-created surround sound speaker channels (e.g., left front, center, right front, and so on).

Parametric encoder 136 and be implemented as described above to split each surround sound channel 141 into a left and right channel, and to apply audio processing (in the digital or analog domain) to position the sound for each channel at the appropriate position in the listening environment. As described above, such positioning can be accomplished by adjusting the phase, delay, gain, echo, reverb and other parameters of the left channel relative to the right channel or of both channels simultaneously for a given surround sound effect. This parametric encoding for each channel can be performed on each of the surround sound channels 141, and the left and right components of each of the surround sound channels 141 combined into a composite left and right channel for reproduction by ultrasonic emitters 144. With such processing, the surround sound experience can be produced in a listening environment using only two emitters (i.e., speakers), rather than requiring 5-7 (or more) speakers placed about the listening environment.

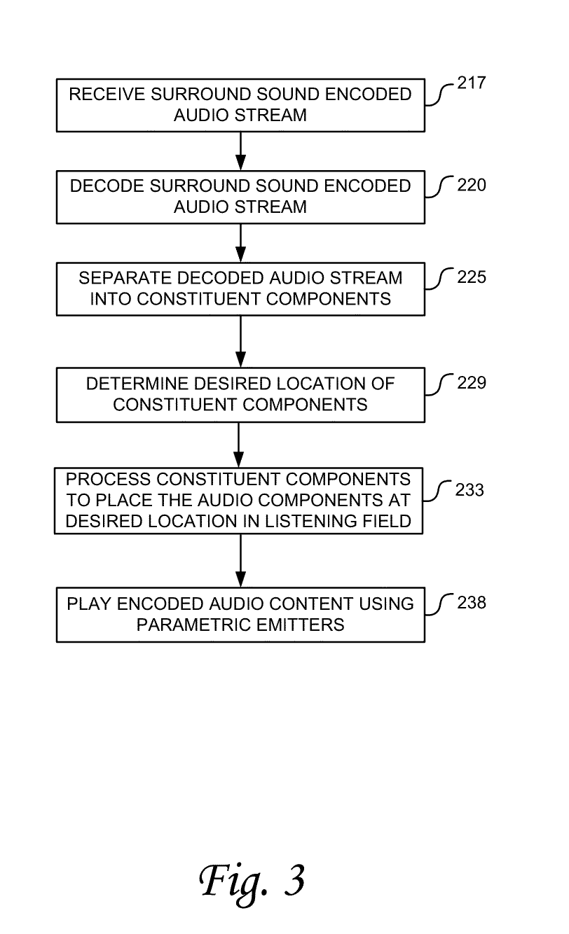

FIG. 3 is a diagram illustrating an example process for generating multi-dimensional audio content in accordance with one embodiment of the systems and methods described herein. Referring now to FIG. 3, in a step 217, surround sound encoded audio content is received, in the form of an audio bitstream. For example, a two-channel Dolby encoded audio stream can be received from a program source such as, for example, a DVD, Blu-Ray Disk, or other program source. At step 220, the surround-sound encoded audio stream is decoded, and the separate channels are available for processing. In various embodiments, this can be done using conventional Dolby decoding that separates an encoded audio stream into the various individual surround channels. This can be done in the digital or analog domains, and the resulting audio streams for each channel can include digital or analog audio content. At step 229, the desired location of these channels is identified or determined. In other words, for example, in terms of a Dolby 7.1 audio content, the desired position for the audio for each of the left front, center front, right front, left surround, right surround, back left surround and back right surround channels is determined. A digitally encoded Dolby bitstream can be received, for example, from a program source such as DVD, BlueRay, other audio program source.

At step 233, the channels are processed to “place” each audio channel at the desired location in the listening field. For example, in terms of the embodiment described above, each channel is divided into two channels (for example, a left and a right channel) the appropriate processing applied provide spatial context for the channel. In various embodiments, this can involve adding a differential phase shift, gain, echo, reverb, and other audio parameter to each channel relative to the other for each of the surround channels to effectively place the audio content for that channel at the desired location in the listening field. In some embodiments, for the center front channel, no phase or gain differentials are applied to the left and right channels so that the audio appears to be coming from between the two emitters. At step 238, the audio content is modulated to ultrasonic frequencies and played through the pair of parametric emitters.

In some embodiments, parametric processing is performed with the assumption that the pair of parametric emitters will be placed like conventional stereo speakers—i.e, in front of the listener and separated by distance to the left and right of the center line from the listener. In other embodiments, processing can be performed to account for placement of the parametric emitters at various other predetermined locations in the listening environment. By adjusting parameters such as the phase and gain of the signal being sent to one emitter relative to the signal being sent to the other emitter, placement of the audio content can be achieved at desired locations given the actual emitter placement.

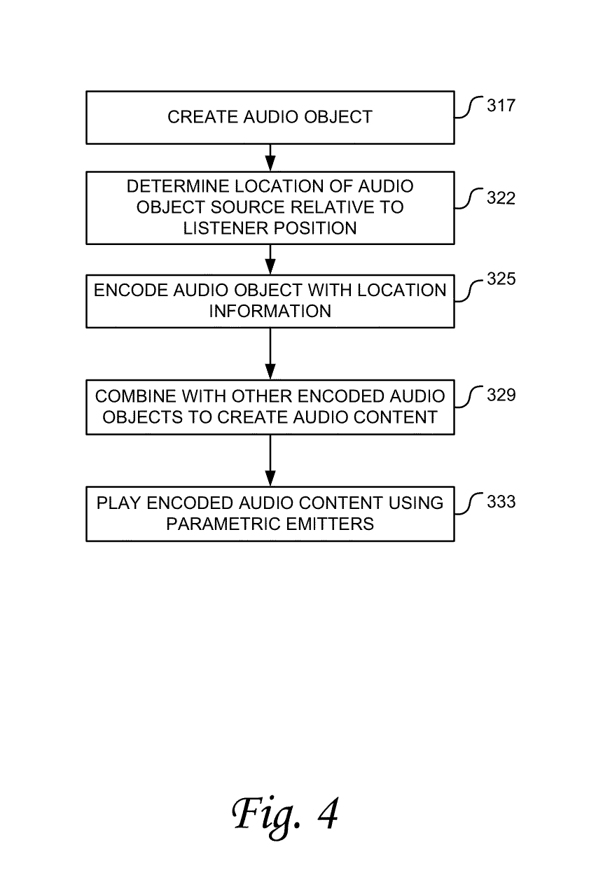

FIG. 4 is a diagram illustrating an example process for generating and reproducing multidimensional audio content using parametric emitters in accordance with one embodiment of the systems and methods described herein. An example application for the process shown in the embodiment of FIG. 4 is an application in the video game environment. In this example application, various audio objects are created with their positional or location information already built in or embedded such that when played through is a pair of parametric emitters, the sound of each audio object appears to be originating from the predetermined desired location.

Referring now to FIG. 4, at step 317 an audio object is created. In the example of the video game environment, an audio object can be any of a number of audio sounds or sound clips such as, for example, a footstep, a gunshot, a vehicle engine, or a voice or sound of another character, just to name a few. At step 322 the developer determines the location of the audio object source relative to the listener position. For example at any given point in a war game, the game may generate the sound of gunfire (or other action) emanating from a particular location. For example, consider the case of gunfire originating from behind and to the left of the gamer's current position. With this known position, at step 325 the audio object (gunfire in this example) is encoded with the location information such that when it is played to the gamer using the parametric emitters, the sound appears to emanate from behind and to the left of the gamer. Accordingly, when the audio object is created, it can be created as an audio object having two channels (e.g., left and right channels) with the appropriate phase and gain differentials, and other audio characteristics, to cause the sound to appear to be emanating from the desired locations.

In some embodiments, the sound can be prestored as library objects with the location information or characteristics already embedded or encoded therein such that they can be called from the library and used as is. In other embodiments, generic library objects are stored for use, and when called for application in a particular scenario are processed to apply the position information to the generic object. Continuing with the gunfire example, in some embodiments gunfire sounds from a particular weapon can be stored in a library and, when called, processed to add the location information to the sound based on where the gunfire is to occur relative to the gamer's position.

At step 329, the audio components with the location information are combined to create the composite audio content, and at step 333 the composite audio content is played to the user using the pair of parametric emitters.

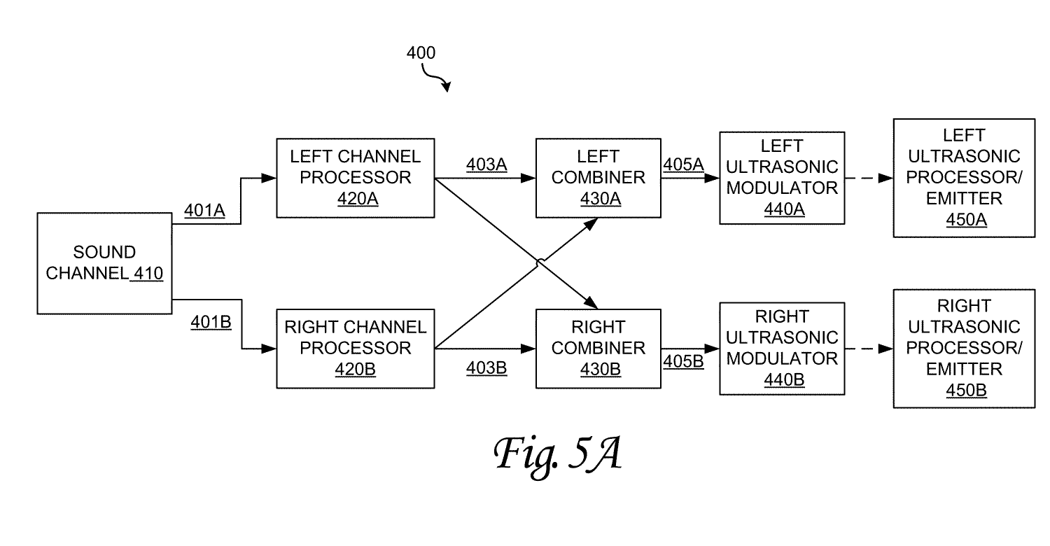

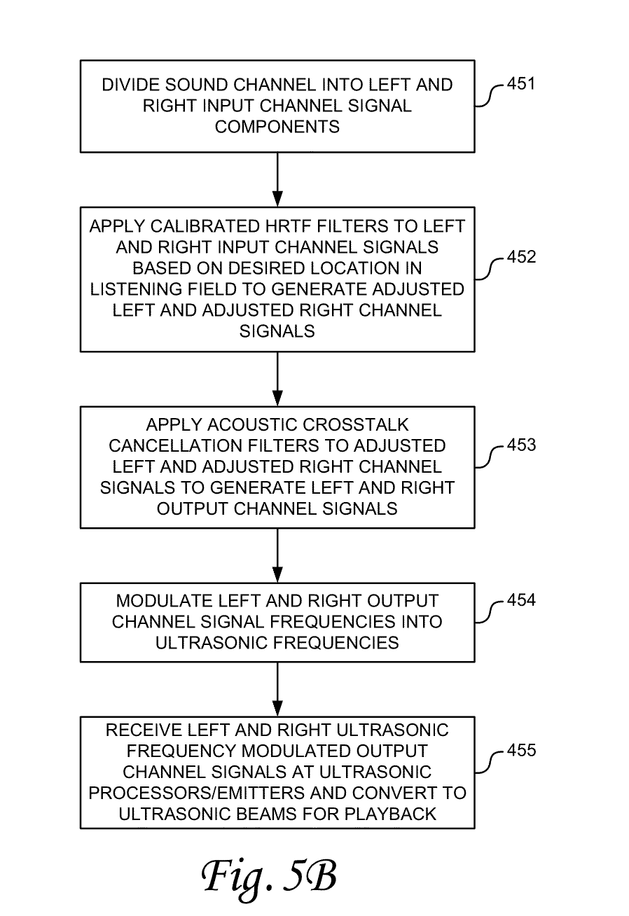

FIG. 5A is a diagram illustrating an example processing module of a parametric encoder that may be implemented to encode a sound channel 410 baseband audio signal into left and right ultrasonic frequency modulated output channel signals for processing and transmission by ultrasonic processors/emitters 450A and 450B. In some applications, the system may receive left and right channels for processing such as, for example, in a stereo sound environment. In other embodiments, a sound channel 410 can be divided into two component channels (left and right) for processing. In this example, circuitry 400 comprises channel processors 420A and 420B for processing the left and right channels relative to each other to effectively place the audio content of the sound channels at the desired location in the listening field.

As further described below, channel processors 420A and 420B comprise head-related transfer function (HRTF) filters for encoding the sound channel in three dimensional space based on the expected response of a listener who is listening to the sound emitted from a plurality of ultrasonic emitters. Circuitry 400 may also include combiners 430A, 430B and ultrasonic modulators 440A, 440B. The combiners may be included to cancel some or all of the acoustic crosstalk that may occur between ultrasonic emitters 450A and 450B. The ultrasonic modulators modulate each output left and output right channel audio signal 405A and 405B onto an ultrasonic carrier at ultrasonic frequencies.

Prior to encoding, a head-related transfer function (HRTF) is calibrated for the left and right ears of the listener of the audio content to more accurately synthesize the 3D sound source. Because different individual listeners have different geometries (e.g. torso, head, and pinnae) with different sound reflection and diffraction properties, their ears will respond differently to sound received from the same point in space. The calibrated HRTF estimates the response of a listener's ears relative to a sound source's (e.g. ultrasonic emitter) frequency, position in space, and delay. In one embodiment, the HRTF is a function of the sound source's frequency, delay, distance from the listener, azimuth angle relative to the listener, and elevation angle relative to the listener. The HRTF in some embodiments can be implemented to specify a plurality of finite impulse response (FIR) filter pairs, one for the left ear and one for the right ear, each filter pair placing a sound source at a specific position in the listening environment.

In one embodiment, the HRTF is calibrated for the listener by selecting a HRTF profile from a predetermined set of HRTF profiles stored on a computer readable medium. In this embodiment, each predetermined HRTF profile may be based on a model listener's geometry, for example, the model listener's head, pinnae, and torso measurements. The listener's geometry may be compared against the geometry of each of the HRTF profiles. A HRTF profile may be automatically selected from a HRTF profile whose model listener's geometry most closely resembles the listener's own geometry. Alternatively, the HRTF profile may be manually selected from the predetermined set of HRTF profiles. In yet further embodiments, the listener may store a custom HRTF profile on the computer readable medium.

In one implementation of this embodiment, an optical imaging system is used to determine the geometry (e.g. head, pinnae, and torso) of the listener for comparison against the predetermined set of HRTF profiles. For example, the optical imaging system may include an optical profilometer with a digital camera and scanning light source. The scanning light source scans the listener's head, pinnae, and torso at a predetermined frequency for a predetermined amount of time, thereby generating approximate measurements of the listener's geometry (e.g. head, pinnae, and torso). In other implementations, the optical imaging system may be based on other known dynamic 3D body scanning technologies. In further embodiments, the optical imaging system may include a depth sensor such as a stereoscopic vision-based or structured light-based sensor. The depth sensor measures the listener's position relative to the ultrasonic emitters.

In one embodiment, the selected HRTF profile may be further refined by using the ultrasonic emitters to play a plurality of sound samples. In this embodiment, when each sound sample is played, the optical imaging system may record the listener's position relative to the left and right ultrasonic emitters. In one implementation of this embodiment, for example, after each sound sample is played the listener is asked to select the perceived location (relative to the listener) of the sound sample. Based on the listener's selections, and the listener's corresponding recorded positions, the parameters of the selected HRTF profile may be refined. In an alternative implementation of this embodiment, the listener wears headphones connected to the parametric audio system. In this implementation, the left and right earpieces of the headphones each include one or more microphones. The ultrasonic emitters play a plurality of sound samples at a plurality of different virtual locations. The headphones record the sound samples at the listener's ears. The recorded sound samples are compared with the original sounds. Based on this comparison and the listener's recorded positions, the HRTF may be calibrated.

Once the listener has completed the HRTF calibration, the parametric audio system may save the listener's HRTF profile for subsequent uses. For example, when the listener subsequently initiates the system, use of the system may only require the listener's selection of the saved HRTF profile. Alternatively, the parametric audio system may comprise a biometric sensor, an imaging sensor (e.g. a camera of an optical imaging system), or other sensing apparatus, that automatically detects the identity of the listener and loads the saved HRTF for that listener.

Parametric encoder circuitry 400 will now be described with respect to FIG. 5B, which is an operational flow diagram illustrating an example method of encoding a sound channel 410. The example encoding process may be applied to a plurality of surround sound channels 410 that make up an original audio content. For example, where multiple microphones were used to record multiple channels of audio content, coder 400 re-creates a sound channel 410 for each microphone channel and encodes it into a left and right channel for producing a three dimensional sound effect for the listener of the audio content.

With reference now to sound channel 410, at operation 451 parametric encoder 400 is included in this example to divide the sound channel into left and right input channel signal components 401A and 401B. The right and left channel signals are encoded with location information that specifies a desired location (azimuthal, elevation, and distance) in the listening field environment of the listener. This can be done, for example, using the techniques described above with reference to FIG. 2. Based on this location information, left and right input channel signals 401A and 401B are subsequently filtered using processing functions (e.g. HRTF filters) to generate a three dimensional sound effect when the signals are output by directional ultrasonic emitters 440A and 440B. In other embodiments, the audio content is provided as a stereo or other 2-channel signal and there is no need to split a sound channel into left and right channels. Accordingly, block 410 may be omitted in various embodiments. Although one advantage that may be obtained in various two-channel embodiments is the ability to achieve a multi-dimensional sound effect with only two audio channels, other embodiments can be implemented for audio content one greater than two channels.

At operation 452, channel processors 420A and 420B apply the calibrated HRTF filters to channel signals 401A and 401B, respectively, based on the desired 3D sound location (azimuthal, elevation, and distance) in the listening field environment of the listener, thereby generating adjusted left channel signal 403A and adjusted right channel signal 403B. In further embodiments, left channel processor 420A and right channel processor 420B may apply additional filters to the left and right channel signals to further enhance the 3D sound effect. For example, the system can be configured to adjust parameters such as the phase, delay, gain, reverb, echo, or other audio parameters, as described above, to enhance the 3D sound effect. As a further example, additional filters may be applied based on characteristics of the listening environment such as the listening environment's physical configuration, the listening environment's background noise, etc.

At operation 453, acoustic crosstalk cancellation filters are applied to the adjusted left and right channel signals to generate left and right output channel signals. FIG. 5A illustrates one specific example implementation of these filters for audio modulated ultrasonic signal. In this specific implementation, because the ultrasonic emitters emit modulated ultrasonic signals, the phase, frequency, and amplitude of the output beams can be assumed approximately constant. The audio signal for one of the two channels is inverted and the delay adjusted for one of the channels relative to the other. For example, in the illustrated example implementation, left combiner 430A performs a phase inversion of signal 403B, delays the inverted signal 403B, and combines it with signal 403A, resulting in output left channel signal 405A. The delay accounts for the difference in time between the arrival of the canceling and interfering signals at the listener's left ear. In one embodiment, this delay may be determined based on the optical imaging system recording the listener's interaural distance (i.e. ear separation) and the listener's position relative to the left and right ultrasonic emitters. In various embodiments, phase inversion and delay can be performed by processing blocks other than the combiner. For example, phase delay and inversion can be performed by left or right channel processors 420A, 420B.

When the ultrasonic beams collide, the left channel audio is cancelled out via destructive interference and does not become audible when the beams intersect. Similarly right channel audio may be cancelled out if right channel combiner 430B phase inverts signal 403A, delays the inverted signal 403A, and combines it with signal 403B, thereby generating output signal 405B. In further embodiments, the reflection and filtering properties of the listening environment may also be considered as filter parameters for combiners 430A and 430B.

At operation 454, the left and right output channel audio signal frequencies are modulated or upconverted to ultrasonic frequencies using left ultrasonic modulator 440A and right ultrasonic modulator 440B. The ultrasonic-frequency modulated output signals may subsequently be played by ultrasonic emitters. At operation 455, the modulated left output channel signal is received by left ultrasonic processor/emitter 450A and the modulated right output channel signal is received by right ultrasonic processor/emitter 450B. the ultrasonic processors respectively convert the received signals to ultrasonic beams for output by the emitters, thereby generating a realistic and substantially noise-free 3D sound effect in the listening field environment of the listener. In some embodiments, ultrasonic processors/emitters 450A, 450B can comprise an amplifier and an ultrasonic emitter such as, for example, a conventional piezo or electrostatic emitter. Examples of filtering, modulation and amplification, as well as example emitter configurations are described in U.S. Pat. No. 8,718,297, titled Parametric Transducer and Related Methods, which is incorporated herein by reference in its entirety.

The disclosed use of 1) HRTF filters for 3D sound production and 2) acoustic crosstalk cancellation filters is made effective by the disclosed ultrasonic emitters, which emit focused sound beams (e.g., audio modulated ultrasonic signals) with approximately constant amplitude, phase, and frequency components as the beams propagate through and demodulate in the listening environment. This provides two key benefits over conventional speaker systems. First, one of ordinary skill in the art would not apply HRTF filters with conventional audio speakers for producing 3D sound effects. One reason for this is that the sound pressure waves generated by conventional acoustic audio speakers rapidly change as they propagate through the free space of a listening environment toward the listener's ear. Another reason is that the the sound emitted from conventional audio speakers is not highly directional, making them unable to capitalize on the benefits of the HRTF. For this reason, HRTF filters for 3D effects are usually only used in headphones. Additionally, conventional acoustic speaker systems generally do not employ HRTF filters for 3D sound with acoustic crosstalk cancellation filters because the crosstalk cancellation filters conflict with the HRTF filters. Thus, the disclosed ultrasonic emitter system in various embodiments provides the benefit of employing a headphone-type HRTF function in tandem with the acoustic crosstalk cancellation filters used in speakers.

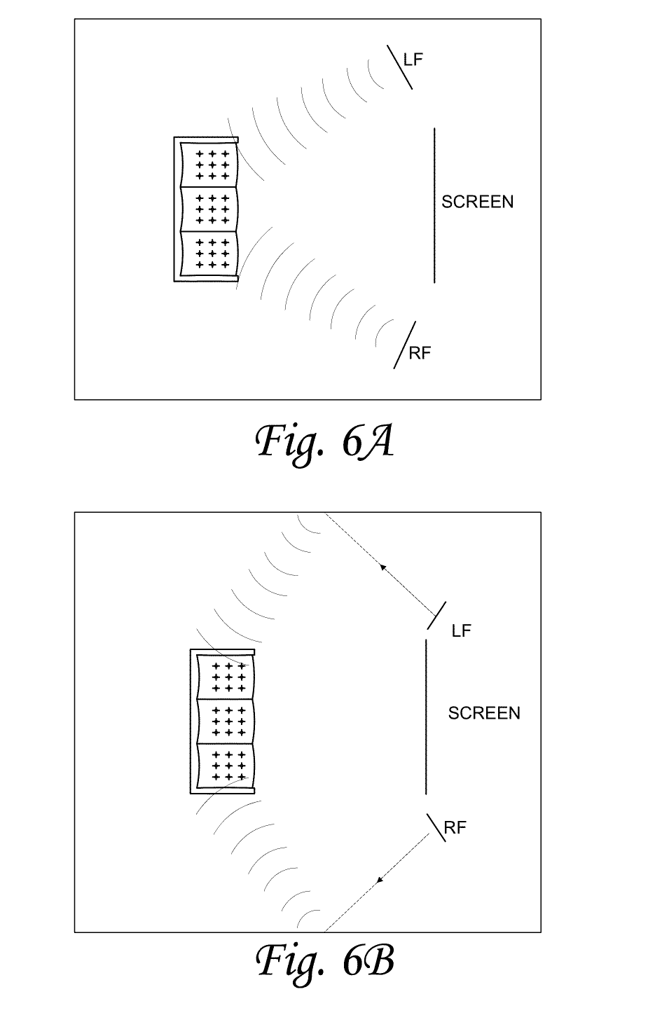

FIGS. 6A and 6B are diagrams illustrating example implementations of the multidimensional audio system in accordance with embodiments of the systems and methods described herein. Referring now to FIG. 6A, in the illustrated example, two parametric emitters are illustrated as being included in the system, left front and right front ultrasonic emitters, LF and RF, respectively. In various embodiments, other quantities of emitters or channels can be used. In this example, the left and right emitters are placed such that the sound is directed toward the left and right ears, respectively, of the listener or listeners of the video game or other program content. Alternative emitter positions can be used, but positions that direct the sound from each ultrasonic emitter LF, RF, to the respective ear of the listener(s) allow spatial imagery as described herein.

In the example of FIG. 6B, the ultrasonic emitters LF, RF are placed such that the ultrasonic frequency emissions are directed at the walls (or other reflective structure including the ceiling or floor) of the listening environment. When the parametric sound column is reflected from the wall or other surface, a virtual speaker or sound source is created. This is more fully described in U.S. Pat. Nos. 7,298,853, and 6,577,738 which are incorporated herein by reference in their entirety. As can be seen from the illustrated example, the resultant audio waves are directed toward the ears of the listener(s) at the determined seating position.

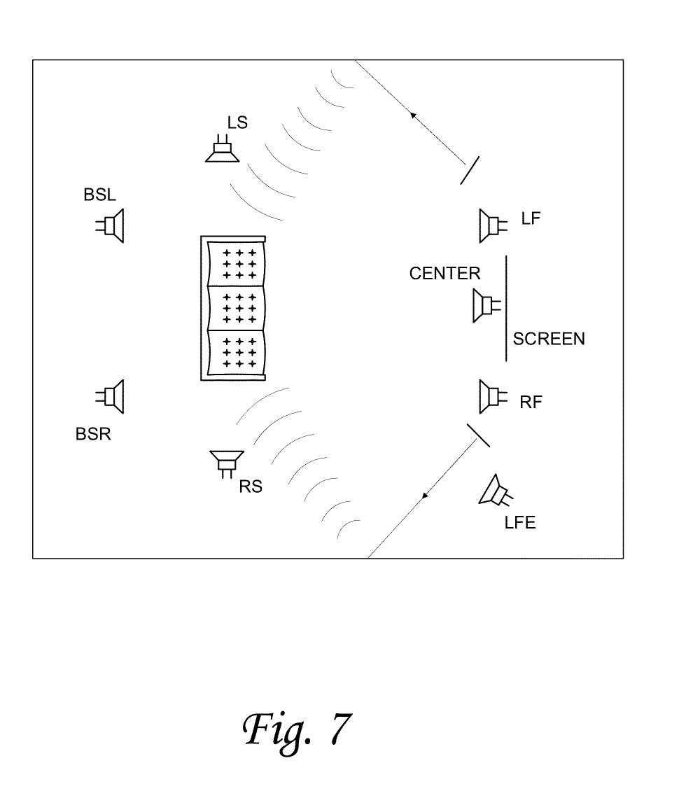

In various embodiments, the ultrasonic emitters can be combined with conventional speakers in stereo, surround sound or other configurations. FIG. 7 is a diagram illustrating an example implementation of the multidimensional audio system in accordance with another embodiment of the systems and methods described herein. Referring now to FIG. 7, in this example, the ultrasonic emitter configuration of FIG. 5B is combined with a conventional 7.1 surround sound system. As would be apparent to one of ordinary skill in the art after reading this description, the configuration of FIG. 5A can also be combined with a conventional 7.1 surround sound system. Although not illustrated, in another example, an additional pair of ultrasonic emitters can be placed to reflect a ultrasonic carrier audio signal from the back wall of the environment, replacing the conventional rear speakers.

In some embodiments, the emitters can be aimed to be targeted to a given individual listener's ears in a specific listening position in the room. This can be useful to enhance the effects of the system. Also, consider an application where one individual listener of a group of listeners is hard of hearing. Implementing hybrid embodiments (such as the example of FIG. 6) can allow the emitters to be targeted to the hearing impaired listener. As such, the volume of the audio from the ultrasonic emitters can be adjusted to that listener's elevated needs without needing to alter the volume of the conventional audio system. Where a highly directional audio beam is used from the ultrasonic emitters and targeted at the hearing impaired listener's ears, the increased volume from the ultrasonic emitters is not heard (or is only detected at low levels) by listeners who are not in the targeted listening position.

In various embodiments, the ultrasonic emitters can be combined with conventional surround sound configurations to replace some of the conventional speakers normally used. For example, the ultrasonic emitters in FIG. 6 can be used as the LS, RS speaker pair in a Dolby 5.1, 6.1, or 7.1 surround sound system, while conventional speakers are used for the remaining channels. As would be apparent to one of ordinary skill in the art after reading this description, the ultrasonic emitters may also be used as the back speakers BSC, BSL, BSR in a Dolby 6.1 or 7.1 configuration.

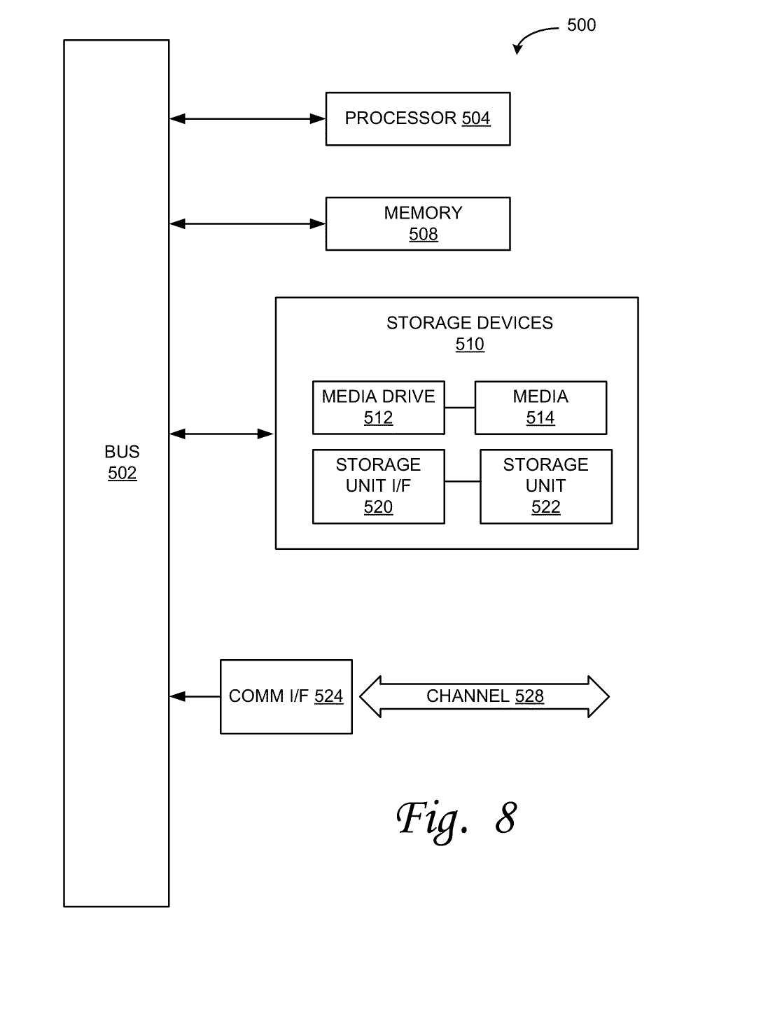

Although embodiments are described herein using a pair of ultrasonic emitters, other embodiments can be implemented using more than two emitters.

Where components or modules of the invention are implemented in whole or in part using software, in one embodiment, these software elements can be implemented to operate with a computing or processing module capable of carrying out the functionality described with respect thereto. One example computing module is shown in more detail in FIG. 8. Various embodiments are described in terms of this example-computing module 500. After reading this description, it will become apparent to a person skilled in the relevant art how to implement the invention using other computing modules or architectures.

Referring now to FIG. 8, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, and storage devices such as storage unit 520, and media 514. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of producing multi-dimensional parametric audio, comprising:
determining head-related transfer function (HRTF) filters for the left and right ears of a listener;
applying the HRTF filters to left and right input channel signals to generate adjusted left and adjusted right channel signals;
applying acoustic crosstalk cancellation filters to the adjusted left and adjusted right channel signals to generate left output and right output channel signals;
modulating the left and right output channel signal frequencies onto an ultrasonic carrier; and
playing the modulated left and right output channel signals using a left ultrasonic emitter and a right ultrasonic emitter.

2. The method of claim 1, wherein determining HRTF filters for the left and right ears of the listener comprises scanning the listener with an optical imaging system to determine a profile of the listener, wherein the profile of the listener comprises the head, pinna, and torso measurements of the listener.

3. The method of claim 2, wherein determining HRTF filters for the left and right ears of the listener further comprises:
comparing the scanned profile of the user with a predetermined set of HRTF profiles, each profile comprising a predetermined range of head, pinna, and torso measurements; and
automatically selecting one of the predetermined set of HRTF profiles.

4. The method of claim 2, wherein determining HRTF filters for the left and right ears of the listener further comprises:
playing a plurality of sound samples at a predetermined frequency;
recording the sound samples at a plurality of microphones, wherein the plurality of microphones are configured for placement in the listener's left and right ears during recording; and
recording the listener's position relative to the left and right ultrasonic emitters using the optical imaging system when each sound sample is recorded.

5. The method of claim 2, wherein determining HRTF filters for the left and right ears of the listener further comprises:
playing a plurality of sound samples;
receiving input from the listener identifying the apparent location of each received sound sample relative to the listener; and
recording the listener's position relative to the left and right ultrasonic emitters using the optical imaging system when each input is received.

6. The method of claim 1, wherein applying acoustic crosstalk cancellation filters to the adjusted left and adjusted right channel signals to generate left and right output channel signals comprises:
phase inverting the adjusted right channel signal and the adjusted left channel signal;
adding a delay to the phase-inverted adjusted right channel signal;
adding a delay to the phase-inverted adjusted left channel signal;
combining the adjusted left channel signal with the delayed phase-inverted adjusted right channel signal to generate the left output channel signal; and
combining the adjusted right channel signal with the delayed phase-inverted adjusted left channel signal to generate the right output channel signal;

7. The method of claim 6, wherein applying acoustic crosstalk cancellation filters to the adjusted left and adjusted right channel signals further comprises applying amplitude, phase, or frequency adjustments to at least one of the adjusted right channel signal and the adjusted left channel signal.

8. The method of claim 6, wherein the HRTF filters are applied based on a desired spatial positioning of audio emitted by the left and right ultrasonic emitters.

9. The method of claim 1, further comprising processing a sound channel into the left and right input channel signals.

10. The method of claim 9, further comprising:
generating a plurality of left output and right output channel signal pairs for a corresponding plurality of sound channels;
combining the plurality of left output signals to generate a composite left output signal; and
combining the plurality of right output signals to generate a composite right output signal.

11. The method of claim 2 wherein the optical imaging system is an optical profilometer.

12. A multi-dimensional parametric audio system, comprising:
means for determining head-related transfer function (HRTF) filters for the left and right ears of a listener;
a parametric audio encoder configured to:
apply the HRTF filters to left and right input channel signals to generate adjusted left and adjusted right channel signals; and
apply acoustic crosstalk cancellation filters to the adjusted left and adjusted right channel signals to generate left output and right output channel signals;
frequency modulating the left and right output channel signal frequencies onto an ultrasonic carrier; and
left and right ultrasonic emitters configured to play the modulated left output and right output channel signals.

13. The system of claim 12, wherein the means for determining head-related transfer function (HRTF) filters for the left and right ears of the listener comprises an optical imaging system that scans the listener to determine a HRTF profile of the listener, wherein the HRTF profile of the listener comprises the head, pinna, and torso measurements of the listener.

14. The system of claim 13, wherein the means for determining head-related transfer function (HRTF) filters for the left and right ears of the listener is further configured to:
play the scanned profile of the user with a predetermined set of HRTF profiles, each profile comprising a predetermined range of head, pinna, and torso measurements; and
automatically selecting one of the predetermined set of HRTF profiles.

15. The system of claim 13, wherein the means for determining head-related transfer function (HRTF) filters for the left and right ears of the listener is further configured to:
play a plurality of sound samples at a predetermined frequency;
record the sound samples at a plurality of microphones, wherein the plurality of microphones are configured for placement in the listener's left and right ears during recording; and
record the listener's position relative to the left and right ultrasonic emitters using the optical imaging system when each sound sample is recorded.

16. The system of claim 13, wherein the means for determining head-related transfer function (HRTF) filters for the left and right ears of the listener is further configured to:
play a plurality of sound samples at a predetermined frequency;
receive input from the listener identifying the apparent location of each received sound sample relative to the listener; and
record the listener's position relative to the left and right ultrasonic emitters using the optical imaging system when each input is received.

17. The system of claim 12, wherein applying acoustic crosstalk cancellation filters to the adjusted left and adjusted right channel signals to generate left and right output channel signals comprises:
phase inverting the adjusted right channel signal and the adjusted left channel signal;
adding a delay to the phase-inverted adjusted right channel signal;
adding a delay to the phase-inverted adjusted left channel signal;
combining the adjusted left channel signal with the delayed phase-inverted adjusted right channel signal to generate the left output channel signal; and
combining the adjusted right channel signal with the delayed phase-inverted adjusted left channel signal to generate the right output channel signal;

18. The system of claim 17, wherein applying acoustic crosstalk cancellation filters to the adjusted left and adjusted right channel signals further comprises applying amplitude, phase, or frequency adjustments to at least one of the adjusted right channel signal and the adjusted left channel signal.

19. The system of claim 17, wherein the HRTF filters are applied based on a desired spatial positioning of audio emitted by the left and right ultrasonic emitters.

20. The system of claim 11, wherein the parametric audio encoder is further configured to:
receive an audio component corresponding to a sound channel; and
process the audio component into the left and right input channel signals.

21. The system of claim 20, wherein the parametric audio encoder is further configured to:
generate a plurality of left and right output channel signals for a corresponding plurality of sound channels;
combine the plurality of left output signals to generate a composite left output signal; and
combine the plurality of right output signals to generate a composite right output signal.

22. The system of claim 13, wherein the optical imaging system is an optical profilometer.
